(19) United States
(12) Patent Application Publication
(10) Pub. No.: US 2017/0118997 A1
(43) Pub. Date: May 4, 2017

(54) NON-TOXIC INSECTICIDE COMPOSITION

(71) Applicant: Terry Rewis, Macclenny, FL (US)

(72) Inventor: Terry Rewis, Macclenny, FL (US)

(21) Appl. No.: 14/926,960

(22) Filed: Oct. 29, 2015

(51) Int. Cl. A01N 65/44; A01N 59/00; A01N 59/04

(52) U.S. Cl. CPC A01N 65/44; A01N 59/04; A01N 59/00

(57) ABSTRACT

A non-toxic insecticide composition includes a mixture containing baking soda, sugar, diatomaceous earth and ground corn, ground wheat or a mixture of ground corn and ground wheat.

BACKGROUND OF THE DISCLOSURE

### Field of the Disclosure

The disclosure relates to insecticides and more particularly pertains to a new insecticide for killing insects and in particular ants while providing an insecticide which is non-toxic to humans.

### SUMMARY OF THE DISCLOSURE

An embodiment of the disclosure meets the needs presented above by generally comprising a mixture containing baking soda, sugar, diatomaceous earth and ground corn, ground wheat or a mixture of ground corn and ground wheat.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### DESCRIPTION OF THE PREFERRED EMBODIMENT

As best illustrated in FIGS. 1 through 6, the non-toxic insecticide composition 10 generally comprises a mixture which consists of baking soda, sugar, diatomaceous earth and ground corn or ground wheat. Specifically, the sugar may comprise conventional granulated sugar or powdered sugar. The diatomaceous earth may include food grade varieties which are widely available from a number of suppliers. Food grade would typically be used to ensure that it is safe for human consumption. The ground corn and ground wheat may be utilized individually or together. The ground corn may be provided as corn meal. The ground wheat may more particularly comprise wheat semolina and thus not include the bran of the wheat kernels. The above ingredients are mixed together within a blender or other similar mechanical blending/mixing device to form a homogeneous mixture.

More specifically, the mixture includes:
10-20% by weight baking soda
10-20% by weight sugar
10-20% by weight diatomaceous earth
40-70% percent by weight ground corn, ground wheat or a mixture thereof

Ideally, the mixture includes:
15% by weight baking soda
15% by weight sugar
15% by weight diatomaceous earth
55% percent by weight ground corn, ground wheat or a mixture thereof

In use, the mixture, after blending is poured into a vertical hole which extends into an insect nest. The insect nest would typically be an ant nest. The mixture is also poured around an outside of the next in a circle having a diameter between 6.0 inches and 10.0 inches. The sugar attracts the ants that will eat the mixture and thereafter will be killed by the baking soda, diatomaceous earth, ground corn and ground wheat. However, should any human or animal such as a dog ingest the mixture, the mixture will cause no ill effects, particularly in quantities of less than 1 cup. In this manner the mixture is safe for usage where there is a risk that children might be exposed to the mixture.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. (canceled)

2. The insecticide according to claim 1, wherein said mixture includes:
between 10 percent and 20 percent by weight of said baking soda;
between 10 percent and 20 percent by weight sugar;
between 10 percent and 20 percent by weight diatomaceous earth; and
between 40 percent and 70 percent by said weight ground corn, said ground wheat or said mixture of ground corn and ground wheat.

3. An insecticide comprising:
a mixture including:
15 percent by weight baking soda;
15 percent by weight sugar;
15 percent by weight diatomaceous earth; and
55 percent by weight ground corn, ground wheat or a mixture of ground corn and ground wheat.
